(19) United States
(12) Patent Application Publication
(10) Pub. No.: US 2008/0286511 A1
(43) Pub. Date: Nov. 20, 2008

(54) Multilayer film structure

(76) Inventor: Manuel Chiu, Oakville (CA)

Correspondence Address: OGILVY RENAULT LLP, 1981 MCGILL COLLEGE AVENUE, SUITE 1600, MONTREAL, QC, H3A2Y3, CA

(21) Appl. No.: 11/798,559

(22) Filed: May 15, 2007

(51) Int. Cl. B32B 1/02; B32B 27/08; B32B 27/32

(52) U.S. Cl. 428/35.7; 428/220

(57) ABSTRACT

The present multilayer film structure includes an inner layer, an outer layer and at least a core layer between the inner and the outer layers, wherein the core layer comprises ethylene polypropylene co-polymer at 60 to 35% weight percent of the core layer, and at least one of linear low density polyethylene, ultra low density polyethylene and metallocene. The multilayer film structure has a thickness of at least 75 μm, and the ethylene polypropylene co-polymer is 5 to 20% of the multilayer film structure. The invention also concerns bags made with the multilayer structure.

### BACKGROUND OF THE INVENTION

1. Technical Field

The present invention concerns a multilayer film structure which is suitable for the producing industrial plastic bags containing various dense, abrasive and/or corrosive materials.

2. Description of the Prior Art

Industrial plastic bags that contain dense, abrasive, and/or corrosive materials require a wall structure that ensures that the contents of the bag are not easily spilled. Thus, these types of bags must have a high ultimate and yield strength, as well as stiffness (as measured by 1% secant test). These bags must have film structures that are also resistant to puncturing, and tearing, and seal securely and easily.

The prior art teaches a variety of multilayer film structures that can be used to produce multilayer containing bags. U.S. Pat. No. 5,846,620 teaches an article, such as a bag that is non-cross laminated film having a burst strength of at least 300 inches of water. U.S. Pat. No. 6,794,053 also teaches a multilayer film structure used in the production for small liquid pouches. The prior art does not teach a multilayer film structure suitable for enclosing various dense, abrasive and/or corrosive materials, and the means of modifying the physical properties of the multilayer film such that the film is appropriately matched for the particulate material being retained therein.

A common film type used in the prior art for retaining particulate and other materials in industrial plastic bags, has typically been a thick film comprising a blend of polymers that includes linear low density polyethylene and low density polyethylene and various additives like color masterbatch and ultraviolet (UV) inhibitors. This type of film is often referred to as a monolayer film. The monolayer film is typically a single layer but may include more than one layer. The layers of such a film tend to appear as a pancake “monolayer”, all of which are produced with the same blend of polymers.

The monolayer bags of the prior art suffer from various disadvantages such as, longer sealing times then heterogeneous or multilayer film structures during bag production. Monolayer films do have good tear resistance, and other physical properties such as ultimate and yield strength, however monolayer films limit the manufacturer's ability to “down gauge” (reduce the film thickness) without comprising properties, such as secant (stiffness) and yield strength. The change in these properties with down gauging affects the sealing properties of the film.

The multilayer film structures of the present invention have improved strengths, optimized tear resistance, dart impact, and while maintaining superior sealing properties over the prior art.

### SUMMARY OF THE INVENTION

In one aspect of the invention there is a multilayer film structure comprising at least: an inner layer, an outer layer and a core layer between the inner layer and the outer layer, wherein the inner layer comprises at least one of linear low density polyethylene and metallocene; the outer layer comprises at least one of linear low density polyethylene, low density polyethylene and metallocene; and the core layer comprises ethylene polypropylene co-polymer at 60 to 35% weight percent of the core layer, and at least one of linear low density polyethylene at 0 to 60% weight percent of the core layer, ultra low linear density polyethylene at 0 to 40% weight percent of the core layer and metallocene at 0 to 40% weight percent of the core layer; wherein the multilayer film structure has a thickness of at least 75 μm and the ethylene polypropylene co-polymer is 5 to 20% weight percent of the multilayer film structure.

A bag comprising a multilayer film structure comprising at least: an inner layer, an outer layer and a core layer between the inner layer and the outer layer, wherein the inner layer comprises at least one of linear low density polyethylene and metallocene; the outer layer comprises at least one of linear low density polyethylene, low density polyethylene and metallocene; and the core layer comprises ethylene polypropylene co-polymer at 60 to 35% weight percent in the core layer, and at least one of linear low density polyethylene at 0 to 60% weight percent in the core layer, ultra low linear density polyethylene at 0 to 40% weight percent in the core layer and metallocene at 0 to 40% weight percent in the core layer; wherein the multilayer film structure has a thickness of at least 75 μm and the ethylene polypropylene co-polymer is 5 to 20% weight percent of the multilayer film structure.

### BRIEF DESCRIPTION OF THE DRAWINGS

Further features and advantages of the present invention will become apparent from the following detailed description, taken in combination with the appended drawings, in which:

FIG. 1 is a cross sectional representation of the multilayer film structure according to one embodiment of the present invention;

FIG. 2 is a further embodiment of the multilayer film structure according to a further embodiment of the present invention having 5 layers; and

FIG. 3 is a graphical representation of the Average Hot Tack v. Test Temperature for a control sample compared with several embodiments of multilayer films according to the present invention.

### DETAILED DESCRIPTION OF THE PREFERRED EMBODIMENT

The multilayer films of the present invention can be produced by a variety of methods known to the skilled person. These methods include: lamination by joining the various layers together with adhesives or with heat. In a preferred embodiment the multilayer films of the present invention are produced by a blown film process.

Blown-films are produced by the extrusion of a molten resin through a ring shaped die. The resin is forced around a mandrel within the die, shaped and further extruded through the die in the form of a relatively thick tube. While molten, the relatively thick tube is expanded to produce a “bubble” of specified diameter and a thinner film (when compared to the relatively thick tube). This thinning is achieved with admittance of air up through the die and mandrel at start-up of the blown film production. The blown film is then drawn out by a set of nip rollers which also serve to flatten the “bubble”.

The process requires a ring of cooling air at the outlet of the mandrel, typically on the outer side of the bubble. This ring of air cools the “bubble” and allows easier flattening between the nip rolls.

The multilayer blown film structures can be produced in a similar manner but with multiple extruders and a single die, mandrel and cooling air ring. A bubble is produced and flattened downstream between nip rollers, as previously described.

Various take-off speeds are possible but generally they vary between 10 and 100 m/min, for the thickness of from 3 to 12 mils (75 to 300 μm) for three layer multilayer films structures of the present invention. The skilled person will understand that thicker gauges film will require a larger volume of cooling air for the higher extruder(s) output and faster take-off speeds.

Other parameters of importance are the BUR or Blow Up Ratio which it the ratio of the “bubble” diameter of the blown film leaving the die versus the diameter of the die. Blown films have physical properties that vary depending on the orientation of the film produced. The film properties may vary in the MD or Machine Direction, versus the TD or Transfer Direction. The MD properties of the film are those measured with respect to the direction of the film out from the extruder. TD or Transfer Direction properties are those measured transverse to the MD and are associated with the width of the film structure. To minimize, differences in the MD and TD properties, blown production is usually run at a BUR of between 2 and 2.5. At these ratios the physical properties in the MD and the TD directions are more balanced.

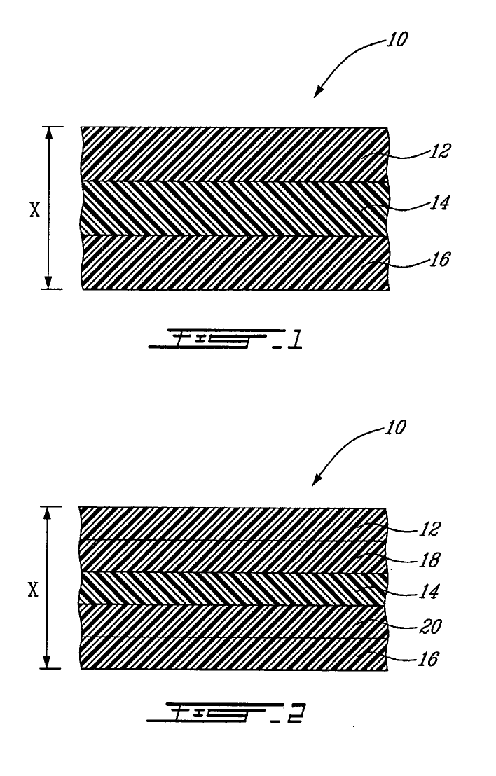

Referring to FIG. 1, the multilayer film structure of the present invention includes at least three layers. In one embodiment the multilayer film structure 10 includes an inner layer 12 an outer layer 16 and a core layer 14 between the inner and the outer layers. The structure 10 is also understood to have a thickness ‘X’, which is greater than 3 mil (75 μm), and for the three layer structure of FIG. 1 typically between 3 and 12 mil (75 to 305 μm).

The composition of the inner layer 12 is selected to ensure superior sealing of the film during bag production. The composition of the inner layer 12 made up of either linear low density polyethylene or metallocene or combinations thereof. Metallocene is a variant of polyethylene with superior properties and a somewhat higher price. Metallocene has superior toughness, as well as tensile, puncture and impact performance resistance. The skilled practitioner would understand that linear low density polyethylene and metallocene may be used in combination in the inner layer.

The outer layer 16 is similar to the inner layer 12, and the two layers are commonly referred to as the “skins” of the film. The composition of the outer layer is either linear low density polyethylene, low density polyethylene or metallocene alone or in combination. However, the outer layer may include additives for color and ultraviolet (UV) protection of the film.

The most common additives in the multilayer films of the present invention include: white masterbatch and UV masterbatch.

The white masterbatch is a polymer that includes a titania pigment that produces a multilayer film structure that is white. The amount of the white masterbatch added depends on the desired colour limited quantities (between 3 and 5% weight percent per film layer) of the white master batch makes for a translucent film while higher amounts (8% weight percent or more per film layer) produce an opaque film product. Clearly, other pigment masterbatches may be used to produce multilayer films of different colors. The composition for other colors would be in a similar range of weight percents to the white masterbatch. Therefore, white masterbatch may be added to the individual layers of the multilayer film of the present invention, particularly the outer layer or the core layer, in a range from 3 to 8% weight percent in the individual layer.

The UV masterbatch is added to the film when the film is expected to be stored outdoors in the sun. The amount of the UV masterbatch varies depending on outdoor storage requirements but is typically in the range of 2-8% weight percent per layer. In the multilayer film it may be found in more than one of the layers but preferably in the outer layer at least.

The white masterbatch and the UV masterbatch are typically added to only the outer and the core layers. However, there may also be occasions when additives may be added to the inner layer at the concentrations proposed above.

The core layer 14 requires an ethylene polypropylene co-polymer to attain the physical properties required by the industrial plastic bags considered herein. The core layer is understood as an inner layer serving a primary purpose and not a layer that serve to adhere two layers to another. In the case of the present invention the ethylene polypropylene co-polymer serves particularly to improve the strength physical properties of the present invention. The ethylene polypropylene co-polymer has a weight percent that varies between 60 and 35% weight percent of the core layer. Furthermore, the ethylene polypropylene co-polymer makes up 5 to 20% weight percent of the total multilayer film structure of the present invention. In a preferred embodiment the total amount of ethylene polypropylene co-polymer in the multilayer film varies between 10 and 14% weight percent, and in a highly preferred embodiment the ethylene polypropylene co-polymer is 12%±1% weight percent in the multilayer film structure. The total weight percent of ethylene polypropylene co-polymer is balanced to ensure that the multilayer film produced has the appropriate physical properties and tear resistance. It will be understood that increasing the ethylene polypropylene co-polymer above a 20% weight percent of the total multilayer film will have a deleterious effect on the tear resistance of the multilayer film.

The remainder of the composition of core layer 14 of the present invention also includes linear low density polyethylene from 0 to 60% weight percent, ultra low linear density polyethylene at 0 to 40% weight percent and metallocene at 0 to 40% weight percent. The weight percents of these four polymers are all given with respect to their concentration in the core layer 14 and each may be found alone or combination with the others. The four polymers typically make up the remainder of the core layer 14 but as was previously discussed may also include small weight percentages of various additives, such that with the ethylene polypropylene co-polymer they make up 100% weight percent of the core layer.

Further preferred compositions of the multilayer film are presented in the Table 1.

TABLE 1

| | Range of composition |
|---|---|
| Layer | (weight percent per layer) |
| Inner Layer | 0 to 100% metallocene, |
| | 0 to 100% linear low density polyethylene, |
| | and combination thereof |
| Core Layer | 60 to 35% ethylene polypropylene |
| | co-polymer, |
| | 0-28.5%-57% linear low density |
| | polyethylene, |
| | 0-28.5% ultra low density polyethylene, |
| | 0-28.5% metallocene |
| | 0-10% additives |
| Outer Layer | 0-95% linear low density polyethylene, |
| | 0-95% metallocene |
| | 0-10% low density polyethylene |
| | 0-10% additives |

The weight ratios of the inner, core and outer layers as a function of the total multilayer film structure varies. The layer weight ratio of the inner/core/outer layers varies from 20/60/20 to 35/30/35 respectively. Preferred embodiments of the layer weight ratios are from 30/40/30 to 33.5/33/33.5 for the inner/core/outer layers respectively. The skilled person would understand that the total weight percent of the ethylene polypropylene co-polymer in the multilayer film can be determined by multiplying the weight percent of the ethylene polypropylene co-polymer in the core layer with the layer weight ratio. For example, if the weight percent of the ethylene polypropylene co-polymer is 35% in the core layer and the core makes up 33 percent of the total weight of the multilayer film, the total percent of the ethylene polypropylene co-polymer in the multilayer film is 11.5%, and thus well within the preferred range of ethylene polypropylene co-polymer in the multilayer film structure.

Suitable multilayer film structures of the present invention include:

I) 100% weight percent linear low density polyethylene in the inner layer; 35% weight percent ethylene polypropylene co-polymer with 55% weight percent linear low density polyethylene and 10% weight percent additives in the core layer; and 80% weight percent linear low density polyethylene and 10% low density polyethylene with the remainder additives in the outer layer;

II) 100% weight percent metallocene in the inner layer; 35% weight percent ethylene polypropylene co-polymer, 28.5% weight percent linear low density polyethylene, 28.5% metallocene, and 10% weight percent additives in the core layer; and 80% weight percent metallocene and 10% low density polyethylene with the remainder additives in the outer layer; and

III) 100% weight percent linear low density polyethylene in the inner layer; 35% weight percent ethylene polypropylene co-polymer with 57% weight percent linear low density polyethylene and 8% additives in the core layer; and 95% weight percent linear low density polyethylene and 5% additives in the outer layer. Although a preferred embodiment, the skilled person would understand that this composition (lacking low density polyethylene in the outer layer), may lead to slower production speeds.

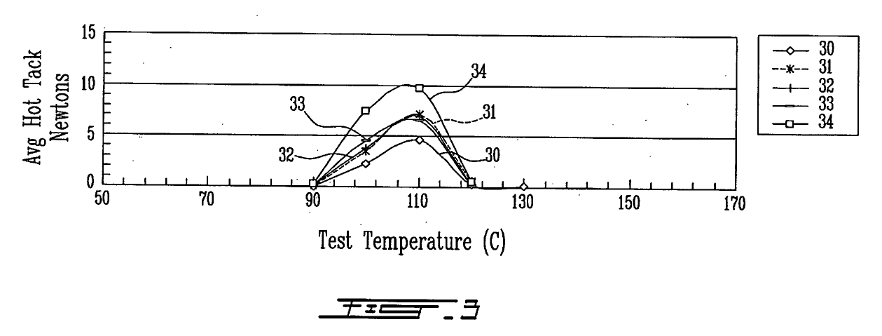

The multilayer films of the present invention may also be produced with more than three layers superimposed on top of each other while the three layers are warm. Typically the layer structure increases in increments of two, such that five, seven, and nine layers may be produced. Although less preferred even numbered multilayer structures greater than three may also be produced. At least one of the inner and outer layers will be further separated from the core layer in multilayer films with more than 3 layers. The layers separating the inner or outer layers from the core layer are called tie layers and generally serve the purpose of adhering two layers together and may comprise a polymer or other material that provides sufficient adhesion to adjacent layers. FIG. 2 represents a five layer film layer structure which includes an inner layer 12 and outer layer 16 and a core layer 14 as previously discussed. The FIG. 2 further includes two intermediate layers 18 and 20.

These intermediate layers 18 and 20, will have structures corresponding to the inner or outer layer to which they are adjacent. Furthermore, the overall thickness “X” of the multilayer structure generally remains the same as that of the three layer structure or in the range of 3-12 mils (75 to 305 μm), or in a preferred embodiment between 5.5 and 6 mil (140-152 μm).

Due to the varied nature of materials that are now sold and transported in polymer bags there is a greater need for specialized properties for various products. The products that the films of the present invention are meant to handle are generally coarse particulates. The particulates may be dense, abrasive, irritants and/or corrosive materials. These particulate materials are typically selected from the group consisting of gravel (aggregate), sand, soil, clay, mortar, cement, powdered fertilizers, pet food, salts (both edible and de-icing road salt), charcoal, charcoal briquettes, peat moss, and wood (chips and kindling) and the like. The list is not meant to be exhaustive, the multilayer film structure of the present invention may be used in other application that are not listed. The multilayer film structure of the present invention is most suitable for larger bags which are meant to hold larger amounts of the material listed above. The skilled person would understand the physical properties required for the material considered. For example, in the case of peat moss, which is packaged by compression into the bag, (where its density is increased roughly three-fold) stiffness (secant) and tear strength are important variables to be considered. While in the case of cement whose density is higher than even densified peat moss and is reasonably abrasive, the film structure would require a higher strength and as well as reasonable tear and puncture resistance.

With no wish to limitative, larger bags are those understood to hold more than 5 lbs. (2.2 kg.), preferably 11 lbs. (5 kg.), more preferably 22 lbs. (10 kg.) and most preferably up to 50 lbs. (22.7 kg.). Stronger and thicker bags may also be produced for quantities up to 80 lbs. (36.3 kg.) and more. The skilled practitioner will understand that the thickness and the properties required will vary depending on the material to retained within the bag and mass of material held within.

The multilayer film structure of the present invention due at least in part to its physical adaptability is also suitable for smaller industrial plastic bags and is particularly suitable for bags known in the industry as “stand-up” poaches. The stiffness, the dart impact and puncture resistance, as well as, the ultimate and yield strengths of the multilayer film of the present invention makes the film particularly suitable for “stand-up” poaches. The “stand-up” poaches of the multilayer film structure of the present invention would be simpler than the presently used “stand-up” poaches which include various laminated layers such as layer(s) of polyester.

A stand-up poach is understood as one that is typically has a base so that it can support itself and stand upright. The stand-up poaches of the present invention would be suitable for materials such as, pet food grass seed.

Physical Performance of the Multilayer Films of the Present Invention as Compared with a Control Monolayer Film

A control monolayer film and four multilayer films of the present invention were produced in a similar manner and such that their dimensions of width and layer thickness were identical.

The five films were produced as blown films, at a Blow-Up Ratio (BUR) of 2:1 and a Lay-Flat width of 25 inches (63.5 cm). The five films all were produced with a thickness of 5.5 mil (140 μm). Finally, the multilayer films were made at a weight layer ratio of 33.5/33/33.5 to Inner/Core/Outer layers respectively. For greater clarity, the Inner layer made up 33.5% weight percent of the multilayer film structure. The Outer layer made up 33.5% weight percent of the multilayer film structure, and the core layer made up 33% weight percent of the multilayer film structure.

The four multilayer film structures according to the present invention were compared with a control monolayer reference film.

The compositions of the control reference monolayer film and the four multilayer film structures of the present invention are presented in Table 2:

TABLE 2
Compositions of the four multilayer films compared
to a control reference monolayer film.

| | Weight Layer | | | |
|---|---|---|---|---|
| | Ratio | | | |
| | (Outer/Core/ | Composition* | | |
| Film | Inner) | Inner Layer | Core Layer | Outer Layer |
| Control Ref. | mono -same | 85% LLDPE, | 85% LLDPE, | 85% LLDPE, |
| Monolayer Film | blend in all | 10% LDPE, | 10% LDPE, | 10% LDPE, |
| | 3 layer | 5% White | 5% White | 5% White |
| Film A | 33.5/33/33.5 | 100% LLDPE | 60% EPPcP, | 95% LLDPE + |
| (20% EPPcP) | | | 32% LLDPE, | 5% white |
| | | | 8% White | |
| Film B | 33.5/33/33.5 | 100% LLDPE | 35% EPPcP, | 90% LLDPE, + |
| (12% EPPcP) | | | 57% LLDPE, | 5% LDPE + 5% |
| | | | 8% White | White |
| Film C | 33.5/33/33.5 | 100% LLDPE | 35% EPPcP, | 90% LLDPE, |
| | | | 28.5% | 5% LDPE, + |
| | | | ULDLPE, | 5% White |
| | | | 28.5% LLDPE, + | |
| | | | 8% White | |
| Film D | 33.5/33/33.5 | 100% | 35% EPPcP, | 90% |
| | | metallocene | 28.5% | metallocene |
| | | | ULDLPE, | 5% LDPE, + |
| | | | 28.5% | 5% White |
| | | | metallocene, | |
| | | | 8% White | |

*THE ABBREVIATIONS IN TABLE 2 ARE DEFINED AS: LLDPE—Linear Low Density Polyethylene; EPPcP—Ethylene PolyPropylene co-Polymer; White - White masterbatch; LDPE—Low Density Polyethylene; ULDLPE—Ultra Low Linear Density Polyethylene; and metallocene - m-polyethylene.

From Table 2 we see that the inner and outer layers of Film A, Film B and Film C are very similar to that of the Control Reference Monolayer Film, therefore we can concluded that any differences in the physical properties of the multilayer film structure are due to the different core layer, and to a large extent to the ethylene polypropylene co-polymer in the core.

TABLE 3
The physical properties of the five films compared.

| | Monolayer | | | | |
|---|---|---|---|---|---|
| | Ref. | MULTILAYER FILM EXAMPLES | | | |
| Film Properties | Film | Film A | Film B | Film C | Film D |
| Puncture (ft-lb/cu in) | 96 | 104 | 106 | 110 | 106 |
| Dart A (gms) | 720 | 756 | 794 | 860 | 1200 |
| Ultimate Strength MD | 5862 | 6330 | 6261 | 6345 | 6985 |
| (psi) | | | | | |
| Ultimate Strength TD | 5609 | 5867 | 5837 | 5592 | 6603 |
| (psi) | | | | | |
| Yield Strength MD | 1674 | 2286 | 2060 | 2001 | 1985 |
| (psi) | | | | | |
| Yield Strength TD | 1727 | 2201 | 1939 | 1862 | 1880 |
| (psi) | | | | | |
| 1% Secant MD (psi) | 39920 | 67333 | 58979 | 54893 | 56418 |
| 1% Secant TD (psi) | 41304 | 68994 | 63293 | 54333 | 56536 |
| Tear MD (g/mil) | 457 | 203 | 382 | 396 | 437 |
| Tear TD (g/mil) | 643 | 350 | 471 | 475 | 564 |

Standard tests were used to determine the physical properties listed above. Particularly for: Puncture: ASTM D 5748 or equivalent. Dart A: ASTM 1709; Ultimate Strength MD/TD: ASTM 882; Yield Strength MD/TD: ASTM 882; 1% Secant MD/TD: ASTM 882 and Tear test was the Elmendorf Tear MD/TD: ASTM 1922.

The core layer and the ethylene polypropylene co-polymer impart superior strength and stiffness to the multilayer film while reducing the tear resistance. This is seen in Table 3, where the multilayer Film A, B, C, and D have superior physical properties than the control reference monolayer film except with respect to tear resistance in the machine direction (MD) and the transfer direction (TD).

The tear resistance properties of the multilayer films where optimized by reducing the ethylene polypropylene co-polymer from 20% to 12% by weight percent of the total multilayer film structure from Film A to Film B. This change is seen in the substantial increase in resistance to tear MD in Film B (382 g/mil) over that of Film A (203 g/mil). Puncture and Dart A resistance also increase in Film B when compared to Film A. Furthermore there is a small reduction in the strength properties, and a fairly significant reduction in the stiffness (1% secant) of the between Film B and Film A.

Film C includes 12% ethylene polypropylene co-polymer and half the linear low density polyethylene in the core layer was replaced with ultra low linear density polyethylene. This change enhances the Puncture, Dart A, and Tear resistance, will reducing the yield Strength and secant properties. However, the TD strength is lowered in film C.

Film D is a premium product which is roughly 5% more expensive to produce than the Films A or B and the control reference monolayer film. In Film D, the Linear Low Density Polyethylene is replaced in the outer layer and the inner layer by the metallocene or m-polyethylene. Half the linear low density polyethylene is also replaced in the core layer by the metallocene. This multilayer film superior strength properties then the control reference monolayer film while attaining comparable tear resistance level. Film D is a premium film, which would be suitable for more costly materials such as premium pet food and premium swimming pool salts and conditioners.

The five films produced were also tested for Hot Tack. The Hot Tack Test is a measure of the sealing strength before the molten seal of the film is cooled. This is an important variable for the form-fill-seal (FFS) high speed packaging operations used to produce bags from film. The Hot Tack vs Temperature curve of FIG. 3 shows the hot tack strength over a range of sealing temperatures. This enables a comparison of various films to compare the hot tack sealing window. The broader the curve, the higher the hot tack strength, and the more forgiving the film will be to perform across a broader range of temperatures and operating conditions. The films have been given the following reference numbers in FIG. 3: the control reference monolayer film, 30; Film A, 31; Film B, 32; Film C, 33; and Film D, 34.

FIG. 3 clearly indicates that all the multilayer films of the present invention have a better hot tack to the control reference monolayer film. The curves 31, 32 and 33 of Film A, B and C respectively are very similar indicating very similar hot tack properties. Curve 34 of Film D is by far the best and indicates that it will perform best over the widest range of operating conditions. FIG. 3 indicates that Films A, B and C (31, 32 & 33) have a similar Avg. hot tack (N, Newtons) at 110° C. of 7.0 N, 7.0 N & 6.5 N (respectively), while Film D (34) has an average hot tack at 110° C. of 10.0N. The films of this invention are suitable for producing bags where the hot tack sealing variable is important, as in form/fill/seal (FFS) bag applications. The multilayer film structure is such that it can produce a seal at more than 6.5 N at a temperature of 110° C., for all Film A, through D presented herein. Equally the production of bags by a horizontal V-fold form/fill/seal or a vertical form/fill/seal used with a tubular film are compatible with the multilayer film structure herein described.

The skilled practitioner armed with the results of these multilayer film structure comparative tests could design a suitable bag having a multilayer film structure according to the present invention that was suitable for a specific particulate material and having specific properties and requirements.

The embodiment(s) of the invention described above is(are) intended to be exemplary only. The scope of the invention is therefore intended to be limited solely by the scope of the appended claims.

1. A multilayer film structure comprising at least:
an inner layer;
an outer layer; and
a core layer between the inner layer and the outer layer,
wherein the inner layer comprises at least one of linear low density polyethylene and metallocene,
the outer layer comprises at least one of linear low density polyethylene, low density polyethylene and metallocene;
the core layer comprises ethylene polypropylene co-polymer at 60 to 35% weight percent in the core layer, and
at least one of linear low density polyethylene at 0 to 60% weight percent in the core layer,
ultra low linear density polyethylene at 0 to 40% weight percent in the core layer and
metallocene at 0 to 40% weight percent in the core layer;
wherein the multilayer film structure has a thickness of at least 75 μm and the ethylene polypropylene co-polymer is 5 to 20% weight percent of the multilayer film structure, and produces an average hot tack seal of more than 6.5N at a temperature of 110° C.

2. The film structure according to claim 1, comprising at least one tie layer between the core layer and at least one of the inner layer and the outer layer, the tie layer comprising at least one of linear low density polyethylene, low density polyethylene, and ultra low density polyethylene.

3. The film structure according to claim 1, wherein the weight layer ratio of the inner/core/outer layers varies from 20/60/20 to 35/30/35 respectively.

4. The film structure according to claim 3, wherein the weight layer ratio of the inner/core/outer layers varies from 30/40/30 to 33.5/33/33.5 respectively.

5. The film structure according to claim 4, wherein the ethylene/polypropylene co-polymer is 10 to 14% weight percent in the multilayer film structure.

6. The film structure according to claim 5, wherein the ethylene/polypropylene co-polymer is 12% ±1% weight percent in the multilayer film structure.

7. The film structure according to claim 6, wherein the outer layer comprises at least 90% weight percent of linear low density polyethylene.

8. The film structure according to claim 7, wherein the inner layer comprises at least 90% weight percent of linear low density polyethylene.

9. The film structure according to claim 1, wherein the inner layer and the outer layer comprise low density polyethylene.

10. (canceled)

11. (canceled)

12. (canceled)

13. (canceled)

14. (canceled)

15. (canceled)

16. A multilayer film structure comprising at least:
an inner layer;
an outer layer; and
a core layer between the inner layer and the outer layer,
wherein the inner layer comprises at least 90% weight percent of linear low density polyethylene,
the outer layer comprises at least one of linear low density polyethylene, low density polyethylene and metallocene;
the core layer comprises ethylene polypropylene co-polymer at 60 to 35% weight percent in the core layer, and
at least one of linear low density polyethylene at 0 to 60% weight percent in the core layer,
ultra-low linear density polyethylene at 0 to 40% weight percent in the core layer and
metallocene at 0 to 40% weight percent in the core layer;
wherein the multilayer film structure has a thickness of at least 75 μm and the ethylene polypropylene co-polymer is 5 to 20% weight percent of the multilayer film structure, and produces an average hot tack seal of more than 6.5N at a temperature of 110° C.

17. The film structure according to claim 16, comprising at least one tie layer between the core layer and at least one of the inner layer and the outer layer, the tie layer comprising at least one of linear low density polyethylene, low density polyethylene, and ultra low density polyethylene.

18. The film structure according to claim 16, wherein the weight layer ratio of the inner/core/outer layers varies from 20/60/20 to 35/30/35 respectively.

19. The film structure according to claim 16, wherein the weight layer ratio of the inner/core/outer layers varies from 30/40/30 to 33.5/33/33.5 respectively.

20. The film structure according to claim 16, wherein the ethylene/polypropylene co-polymer is 10 to 14% weight percent in the multilayer film structure.

21. The film structure according to claim 16, wherein the ethylene/polypropylene co-polymer is 12% ±1% weight percent in the multilayer film structure.
